(19) United States
(12) Patent Application Publication
(10) Pub. No.: US 2023/0125081 A1
(43) Pub. Date: Apr. 27, 2023

(54) AC HEATING CABLE

(71) Applicant: Royal Heritage Home, LLC, New York, NY (US)

(72) Inventors: Michael EUL, St. Paul, MN (US); Thomas LLOYD, Cumming, GA (US); Tyler LLOYD, Cumming, GA (US)

(21) Appl. No.: 17/971,249

(22) Filed: Oct. 21, 2022

Related U.S. Application Data
(60) Provisional application No. 63/270,371, filed on Oct. 21, 2021.

(51) Int. Cl. H05B 3/56; H02G 15/007

(52) U.S. Cl. CPC H05B 3/56; H02G 15/007

(57) ABSTRACT

A heating cable for use with alternating current (AC) may include multiple conductive metal strands. A strain-relief yarn may also be included. The strands may be coated with an electrically-insulating coating. The strands, including the strain-relief yarn, may be twisted together and coated with an electrically-insulating outer coating to provide the heating cable.

### CROSS-REFERENCE TO RELATED APPLICATION

The present application claims priority to U.S. Provisional Patent Application No. 63/270,371, filed on Oct. 21, 2021, the entirety of which is incorporated herein by reference.

### FIELD OF ENDEAVOR

The present disclosure may relate to a heating cable to enable the use of alternating current (AC) power for heating items.

### BACKGROUND

Past heating items, such as, but not limited to, heating blankets, have used direct current (DC) to provide heating. This has necessitated the use of bulky and expensive AC-to-DC converters to provide an appropriate voltage for the heating elements. In more sophisticated heating items, more than one AC-to-DC converter has often been needed, one to provide the appropriate voltage for the heating elements and one (or sometimes more) to provide voltages to control other elements.

It may be advantageous, therefore, to be able to eliminate an AC-to-DC converter by using AC voltage to provide heating. However, to use AC voltage, an appropriate heating cable, that can, e.g., conduct the AC voltage, radiate heat, and have desirable flexing properties may be needed.

### BRIEF DESCRIPTION OF THE DRAWINGS

Various aspects of the present disclosure will now be presented in conjunction with the accompanying drawings, in which:

FIG. 1 shows a conceptual diagram that shows various aspects of the present disclosure;

FIG. 2 shows a conceptual diagram that shows various further aspects of the present disclosure;

FIG. 3 shows a conceptual diagram that shows yet further aspects of the present disclosure;

FIG. 4 shows a conceptual diagram showing a variation related to the aspects of the present disclosure shown in FIG. 3; and

FIG. 5 shows a conceptual diagram of further aspects of the present disclosure.

### DETAILED DESCRIPTION OF ASPECTS OF THE DISCLOSURE

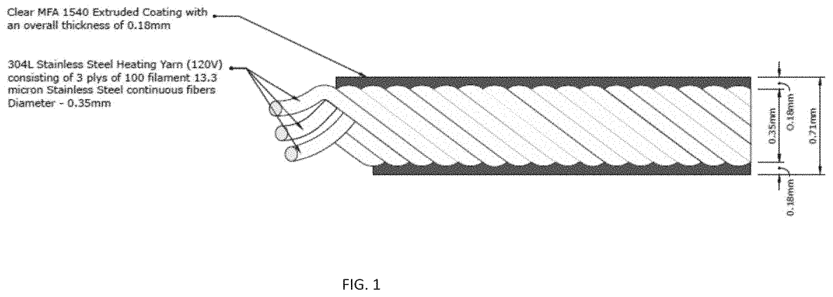

FIG. 1 shows an example of an AC heating cable according to various aspects of the present disclosure.

As shown in FIG. 1, an AC heating cable according to aspects of the present disclosure may include three strands of stainless steel heating yarn twisted (not braided) together, along with an external coating around the three strands of twisted heating yarn.

The external coating may be composed of MFA (polytetrafluoroethylene-perfluoromethylvinylether), which may be extruded onto the twisted heating yarn. The MFA coating may have a thickness of, for example, 0.18 mm (which may be chosen within a range of 0.15 mm to 0.20 mm). The MFA used may provide high temperature resistance and may have good flexibility. The MFA used may withstand service temperatures of between −200° C. and 225° C. with only minor variations in electrical and mechanical properties within this range. It is also highly stable and fire-resistant.

The strands of yarn may be comprised of, for example, three respective plies of filaments of stainless steel, for example, SAE 304 stainless steel. Each ply may contain 100 stainless steel filaments of individual diameter 13.3 microns, twisted together; however, the invention is not thus limited, and other combinations may be possible. The filaments, plies, and strands of yarn may be of continuous construction from end to end. The outer diameter of the twisted strands of yarn may be, for example, 0.35 mm, where the twisted structure may have a substantially round shape in the radial direction.

The total number of filaments in the structure may be chosen to meet a desired linear resistance. According to aspects of this disclosure the linear resistance may be in a range of about 17.3 ohms/m to about 23.4 ohms/m.

The three strands of heating yarn may have a twist specification of 252±3 twists per meter in the “z” direction (i.e., the lengthwise/axial direction of the heating cable).

The twisting within the plies and the twisting of the plies may result in a heating cable that is soft and pliable and well-suited to applications such as heating blankets, heating throws, heated pillows, etc.

A heating cable according to FIG. 1 may be suitable for use with relatively high voltages, such as, but not limited to, a typical building line voltage (e.g., 110V-120V).

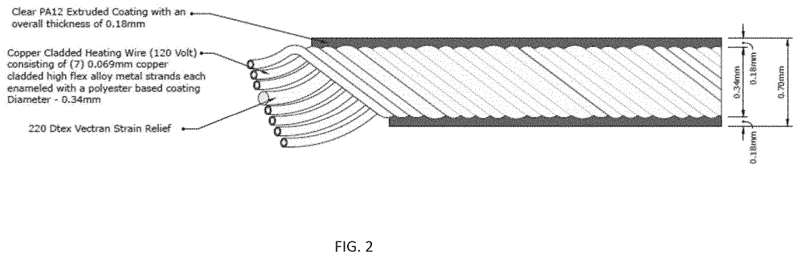

According to further aspects of the present disclosure, FIG. 2 shows a conceptual diagram of a heating cable that may be a copper clad high flex metal stranded heating cable with enameled filaments and an extruded polyamide (PA) insulated coating. The cable may be made up of seven 0.069 mm copper clad strands of high flex alloy metal (although the invention is not thus limited), where each strand may be enameled with a polyester based coating, such as, but not limited to, an E180 polyesteramide (PEA) coating, and all twisted with a very fine diameter synthetic yarn, for example, but not limited to, a liquid crystal polymer (LCP) yarn, e.g., a 220 dtex Vectran® LCP fiber, manufactured by Kuraray America, Inc., to add a strain relief to the cable. The entire cable may be coated with a PA extruded coating, such as, but not limited to, a PA12 coating. The enameling of the individual strands may add to the flex life and may also add an additional safety level. The PA coating may provide a high temperature resistance and may offer good flexibility.

In the above non-limiting example, the number and thickness of the copper strands may be chosen to obtain a desired linear resistance. In this example, the linear resistance may be 19.9 ohms/m; however, the invention is not thus limited. In particular, there may be a range of acceptable linear resistance values, such as 19-21 ohms/m, and a number of copper strands may be chosen to obtain a linear resistance value within the acceptable range.

As with the previous example, the overall radial shape of the heating cable may be round, and the constituent copper fibers and synthetic yarn may extend continuously from one end of the heating cable to the other end of the heating cable.

A cable of the type shown in FIG. 2 may be appropriate for a lower range of voltages, e.g., reduced from a typical building line voltage such as 110V-120V or 210V-220V.

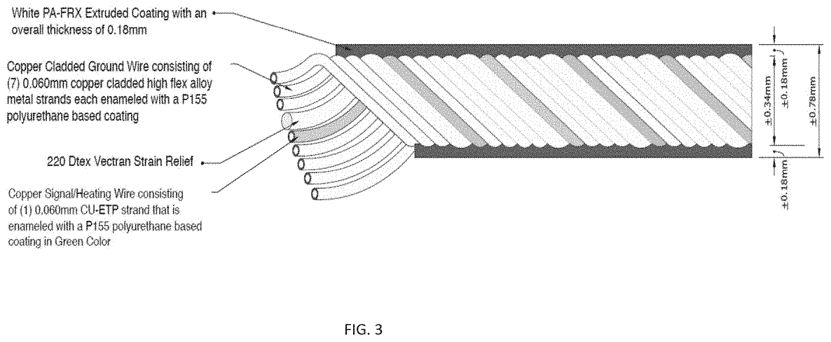

FIG. 3 shows a conceptual diagram of a heating cable according to various further aspects of the present disclosure. A heating cable, while having similarities to the structure of the cable according to FIG. 2, may include differences that may make it suitable for a higher voltage range, such as, but not limited to, 110V-120V.

The heating cable according to FIG. 3 may include a single copper strand, e.g., but not limited to, one of 0.06 mm in diameter. The copper strand may be composed of, for example, Cu-ETP, an electrolytically-refined, oxygen-containing copper; however, the invention is not thus limited. This copper strand may be clad with a polyurethane-based coating, such as, but not limited to, P155. This copper strand may be used to conduct an AC voltage through the cable, to provide heating.

The heating cable according to FIG. 3 may further include a number (e.g., seven, but not thus limited) of further copper strands, e.g., of 0.06 mm diameter, which may, as a group, form a ground wire. The further copper strands may be composed of, for example, a copper alloy, such as, but not limited to, CuSn6, a (primarily) copper-tin alloy. These strands, too, may each be clad with a polyurethane-based coating, e.g., but not limited to, P155 (e.g., Polysol®155, manufactured by Ektrisola Dr. Gerd Schildbach GmbH & Co. KG).

Different colors may be used for the coatings of the heating wire and the ground strands. For example, the coating of the heating wire may be green-colored, while the coatings of the ground stands may be some other color (e.g., but not limited to, clear).

As was the case in FIG. 2, the example of FIG. 3 may also include a very fine diameter synthetic yarn, for example, but not limited to, a liquid crystal polymer (LCP) yarn, e.g., a 220 dtex Vectran® LCP fiber, manufactured by Kuraray America, Inc., to add a strain relief to the cable.

The various copper strands (heating wire and ground), along with the strain-relief yarn, may be twisted together and may be coated with a polyamide-based coating, such as, but not limited PA-FRX, manufactured by FRX Polymers, Inc. This coating may be extruded and may have a thickness of approximately 0.18 mm.

A heating cable constructed as shown in FIG. 3 may provide a linear resistance of approximately 6.9 Ω/m. However, variations on the structure of FIG. 3 may result in different resistance characteristics.

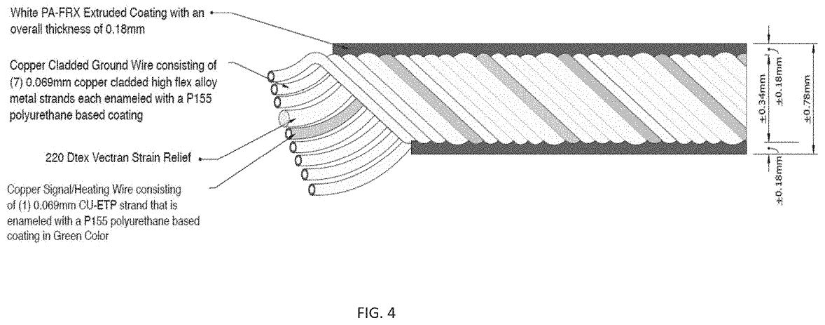

For example, FIG. 4 shows a further example in which the copper heating wire and the copper ground strands have diameters of approximately 0.69 mm. By making this change, the linear resistance may be reduced to approximately 5.4 Ω/m.

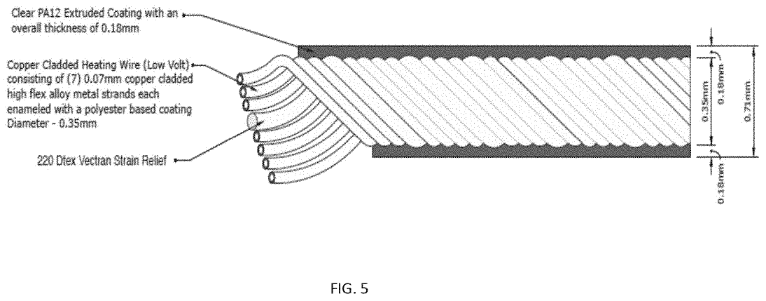

According to further aspects of the present disclosure, FIG. 5 depicts a conceptual diagram of a heating cable that may be used for lower voltages, e.g., reduced from a typical building line voltage. A heating cable according to FIG. 5 may have a structure similar to what is shown in FIG. 2. The variation of FIG. 5 may include a number (e.g., but not limited to, seven) of copper-clad alloy metal strands, where each strand may be coated with a polyester-based coating. The alloy metal may have a high degree of flexibility. A strain relief fiber may be included, the strands and the strain relief fiber may be twisted together, and the entire cable may be coated with a PA-based extruded coating, e.g., but not limited to, PA12.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

What is claimed is:

1. A heating cable including:
at least one heating wire; and
at least one strain-relief yarn,
wherein the at least one copper heating wire is coated with an electrically-insulating coating,
wherein the at least one copper heating wire and the at least one strain-relief yarn are twisted together to form a twisted cable, and
wherein the twisted cable is coated with an electrically-insulating outer coating.

2. The heating cable according to claim 1, wherein the at least one heating wire includes exactly one copper heating wire strand.

3. The heating cable according to claim 2, further including a plurality of ground wire strands that are each coated with a respective electrically-insulating coating, wherein the plurality of ground wire strands are twisted together with the copper heating wire and the strain-relief yarn to form the twisted cable.

4. The heating cable according to claim 3, wherein the ground wire strands are composed of a copper-tin alloy.

5. The heating cable according to claim 3, wherein the electrically-insulating outer coating comprises a polyamide-based coating.

6. The heating cable according to claim 1, wherein the at least one heating wire includes multiple metal alloy strands, wherein each of the metal alloy strands is coated with a polyester-based coating.

7. The heating cable according to claim 6, wherein the metal alloy is a copper alloy.

8. The heating cable according to claim 6, wherein the electrically-insulating outer coating comprises a polyamide-based coating.

9. The heating cable according to claim 1, wherein the at least one heating wire includes multiple stainless steel plies consisting of a plurality of stainless steel filaments twisted together, wherein the multiple stainless steel plies are twisted together, and wherein the strain-relief yarn is omitted.

10. The heating cable according to claim 9, wherein the electrically-insulating outer coating comprises an MFA (polytetrafluoroethylene-perfluoromethylvinylether) coating.
